(19) United States
(12) Patent Application Publication
(10) Pub. No.: US 2026/0273627 A1
(43) Pub. Date: Sep. 17, 2026

(54) Method of Additive Manufacturing

(71) Applicant: UNITED STATES OF AMERICA AS REPRESENTED BY THE ADMINISTRATOR OF NASA, Washington, DC (US)

(72) Inventor: John-Andrew S. Hocker, Indianapolis, IN (US)

(21) Appl. No.: 19/289,248

(22) Filed: Aug. 4, 2025

Related U.S. Application Data
(60) Provisional application No. 63/771,845, filed on Mar. 14, 2025.

(51) Int. Cl. B22F 10/85; B22F 10/28; B22F 12/90; B33Y 10/00; B33Y 30/00; B33Y 50/02

(52) U.S. Cl. CPC B22F 10/85; B22F 10/28; B22F 12/90; B33Y 10/00; B33Y 30/00; B33Y 50/02

(57) ABSTRACT

A method may include: forming a sample part with an additive manufacturing (AM) machine based on build parameters (BPs) describing operation of the AM machine at points of a point field (PF) of the sample part; determining a metric including information describing an aspect of the forming at the points in the PF; inspecting the sample part to find a feature as a function of the PF; creating a training field including the PF, the BPs, the determined metric (DM), and the found feature as a single co-registered PF; training the BPs and the DM, with the found feature as the training field using an AI model; and forming a part based on the trained BPs and the trained DM, so the found feature is absent from the formed part and/or detecting a probability of the found feature being present based on the AI model inspecting an as-built data set.

### CROSS-REFERENCE TO RELATED PATENT APPLICATION(S)

This patent application claims the benefit of and priority to U.S. Provisional Patent Application No. 63/771,845, filed on Mar. 14, 2025, the contents of which are hereby incorporated by reference in their entirety.

### STATEMENT REGARDING FEDERALLY SPONSORED RESEARCH OR DEVELOPMENT

The invention described herein was made by an employee of the United States Government and may be manufactured and used by or for the Government of the United States of America for governmental purposes without the payment of any royalties thereon or therefore.

### BACKGROUND OF THE INVENTION

Additive manufacture (AM) may involve the sequential build-up of material in a predefined pattern to form finished parts. Laser powder bed fusion (PBF-LB/M) is a specific type of AM that uses a powder metal feedstock that is spread upon a flat substrate and fused by a laser heat source. The fusion process requires both the targeted feedstock and the immediately adjacent feedstock/substrate to melt. The short duration, translating melt created by the laser may be referred to as a melt pool, which includes a weld. Melt pool control governs the quality of the weld and, thus, the quality of the part created by the PBF-LB/M AM process.

Build instructions (e.g., a build file to be interpreted by an AM machine) for a given AM machine for the manufacture of a specific part may include settings for parameters of the AM machine. For example, settings for a PBF-LB/M AM machine may include laser power(s), foci for optical parts (e.g., laser(s), lenses, mirrors, and the like), velocities of laser(s) progression through the predefined pattern, sequencing of feedstock additions, thickness of feedstock layers, velocity of feedstock additions, flowrates of feedstock additions, velocity of feedstock leveling devices, and the like.

The build instructions may be used by the AM machine controller to control the various parts of the AM machine during the manufacture of the part. During the build, despite the accuracy of the build instructions, due at least in part to a plethora of potential difficult to predict disturbances to the build (e.g., overheating, underheating, melt spatter, and the like), features (e.g., defects such as cracks, porosity deviations, microstructure deviations, and the like) may form in the part.

Inspection of AM manufactured parts may detect unacceptable features. However, inspection may be expensive and increase the cost of parts made by the AM process. Even when inspection is performed in-situ during the build process, added inspection devices and associated tooling may increase part cost, increase production time/reduce throughput, and may not allow for adjustment to the build in sufficient time to avoid or resolve defects that may occur in the finished part. Accordingly, the cost of AM manufactured parts may be increased relative to other manufacturing methods due at least in part to difficulty in developing robust build instructions that are able to account for real-time deviations in process conditions.

### BRIEF SUMMARY OF THE INVENTION

In accordance with the present disclosure, a method may include: forming a sample part by an additive manufacturing (AM) process with an AM machine based on build parameters describing operation of the AM machine at points of a point field corresponding to at least a portion of the sample part; determining, during the forming the sample part, a metric including information describing an aspect of the forming at the points in the point field; inspecting the sample part to find a feature of the sample part as a function of one or more points of the point field; creating a training field including the point field, the build parameters, the determined metric, and the found feature as a single co-registered point field; training the build parameters and the determined metric, with the found feature as the training field using an artificial intelligence (AI) model; and forming a part by the AM process with the AM machine based on the trained build parameters and the trained determined metric, so that the found feature is effectively absent from the formed part and/or detecting a probability of the found feature being present in the formed part based on the AI model inspecting an as-built data set for a formed part against the trained build parameters and the trained determined metric.

The determined metric may include: a determined metric of the AM machine, the AM process, and/or the formed sample part, and/or a measured condition of the AM machine, the AM process, and/or the formed sample part.

The method may further include classifying the feature of the formed sample part.

The creating the training field may further include appending information of the point field with information corresponding to the found feature.

The method may further include determining a quality of the AI model by validating a prediction of the found feature for the build parameters and the determined metric against information excluded from the training field.

The sample part may include an inspectable geometry including a plurality of inspectable features describing different physical characteristic of the sample part as a function of the point field, and each build parameter of the build parameters is equal to an as-designed build parameter for forming the part.

The forming the sample part may include indexing an interlayer hatch angle between subsequent passes of a forming tool of the AM machine by less than or equal to about 44 degrees.

The forming the sample part may include indexing an interlayer hatch angle between subsequent passes of a forming tool of the AM machine by less than or equal to about 44 degrees, the sample part may include an inspectable geometry including a plurality of inspectable features describing different physical characteristic of the sample part as a function of the point field, and the build parameters may include deviation parameters describing uniform perturbations and/or non-uniform perturbations from a parameter of the build parameters.

The AM machine may include a laser powder bed fusion machine including a laser configured to fuse metal powder stock, the AM process may include a laser powder bed fusion process in which the laser fuses the metal powder stock in a layer-by-layer sequence, and the forming the sample part may include indexing an interlayer hatch angle of the laser between subsequent layers with the AM machine by less than or equal to about 44 degrees.

The inspecting may include XRCT imaging, profilometry, and/or metallography of one or more layers of the sample part.

The metric may include a plurality of determined metrics and/or a plurality of measured conditions respectively corresponding to points in the point field.

The feature may include a defect.

In accordance with the present disclosure, an additive manufacturing machine may include: a tool; and a controller configured to: form a sample part by an additive manufacturing (AM) process with an AM machine based on build parameters describing operation of the AM machine at points of a point field corresponding to at least a portion of the sample part; determine, during the forming the sample part, a metric including information describing an aspect of the forming at the points in the point field; inspect the sample part to find a feature of the sample part as a function of one or more points of the point field; create a training field including the point field, the build parameters, the determined metric, and the found feature as a single co-registered point field; train the build parameters and the determined metric, with the found feature as the training field using an artificial intelligence (AI) model; and form a part by the AM process with the AM machine based on the trained build parameters and determined metric, so that the feature is effectively absent from the formed part and/or detect a probability of the found feature being present in the formed part based on an as-built data set for a formed part inspected by the AI model against the trained build parameters and determined metric.

The determined metric may include: a determined metric of the AM machine, the AM process, and/or the formed sample part, and/or a measured condition of the AM machine, the AM process, and/or the formed sample part.

The controller may be further configured to: classify the feature of the formed sample part.

The controller may be further configured to: validate a prediction of the found feature for the build parameters and the determined metric against information excluded from the training field so as to determine a quality of the AI model.

The sample part may include an inspectable geometry including a plurality of inspectable features describing different physical characteristics of the sample part as a function of the point field, and each build parameter of the build parameters may be equal to an as-designed build parameter for forming the part.

The controller may be further configured to: index an interlayer hatch angle between subsequent passes of a forming tool of the AM machine by less than or equal to about 44 degrees to form the sample part.

The controller may be further configured to: index an interlayer hatch angle between subsequent passes of a forming tool of the AM machine by less than or equal to about 44 degrees to form the sample part, the sample part may include an inspectable geometry including a plurality of inspectable features describing different physical characteristic of the sample part as a function of the point field, and the build parameters may include deviation parameters describing uniform perturbations and/or non-uniform perturbations from a parameter of the build parameters.

The tool may include a laser configured to fuse metal powder stock in a build volume of the AM machine, and the controller may be further configured to: control the laser to fuse the metal powder stock in a layer-by-layer sequence.

These and other features, advantages, and objects of the present invention will be further understood and appreciated by those skilled in the art by reference to the following specification, claims, and appended drawings.

### BRIEF DESCRIPTION OF THE SEVERAL VIEWS OF THE DRAWINGS

FIG. 1 is a schematic illustration of a method of the present disclosure; and

FIG. 2 is an image of an example of an inspectable part of the present disclosure; and

FIG. 3 is a block diagram of a control system for the AM machine and/or AM process of the present disclosure.

### DETAILED DESCRIPTION OF THE INVENTION

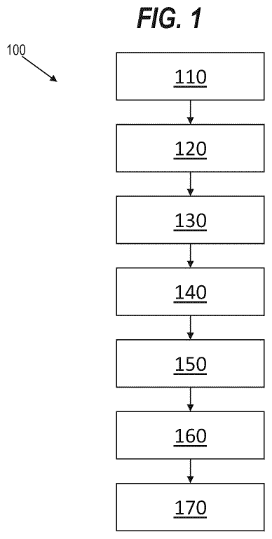

For purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations and step sequences, except where expressly specified to the contrary. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

The present disclosure seeks, at least in part, to (1) build parts using an additive manufacturing (AM) process by an AM machine based on a trained use an artificial intelligence (AI) model (e.g., neural network model, machine learning model, deep learning model, and the like) and/or (2) detect features (e.g., including intentional features and/or non-intentional features such as defects) in a part built by an AM machine by inspecting as-built parameters of the build using a trained AI model. These objectives may allow for the omission of post build inspection processes that may be expensive and/or time consuming thereby increasing the adoption of AM for the production of parts. The methods of the present disclosure may further lead to reduced manufacturing time, improved part quality, and/or reduced part cost.

The presently disclosed method realizes an improvement in AM manufacturing by at least identifying deviations in as-built data that may be indicative of unintentional features (e.g., such as physical characteristics) that may be present in an AM formed part and alerting a process operator of the deviation. Additionally, the presently disclosed method may realize an improvement in AM manufacturing by analyzing thousands, if not hundreds of thousands, of as-built data points, determining relationships between the as-built data points (e.g., between input parameters, determined parameters, and measured parameters as are later described) and manipulating build parameters (e.g., such as input parameters and/or determined parameters as are later described) of subsequent builds to reduce the occurrence of deviations.

As shown in FIG. 1, a method 100 of AM may include a first step 110 which may include determining build parameters for a given AM machine that will be used to conduct a build (e.g., that may be specified in a build file to be executed by a computer system controlling an AM machine such as, e.g., is described in US Patent Publication No. US2023/0373008A1 the entirety of which is incorporated herein by reference). Build parameters may include (1) an input parameter for aspects of the given AM machine (examples include programmed power, speed, hatch spacing, hatch angle, interlayer height, beam size, or beam shape), (2) a determined metric which may be determined from a model (e.g., physics-based models, empirical relationships, and the like) of the AM machine, AM process(es), and/or part being formed (examples include thermal rise, lack of fusion, and spatter impact metrics), and/or (3) a measured condition (e.g., measured by monitoring the AM machine, the AM process(es), and/or a part being formed (e.g., in real-time during the build and/or after formation of the part)) and measured conditions may also be considered as a determined metric (examples include laser power levels, infrared imaging, visible light imaging, coaxial melt pool imaging, and the like). The build parameters may include target values for variables (e.g., measured and/or estimated through modeling, such as a physics-based model, an empirically determined relationship, and the like) of the build process. The following table provides process metrics that may be used.

| PROCESS | |
|---|---|
| METRIC | DESCRIPTION |
| fuse x-axis | The x-axis position in a 3D coordinate record of the |
| position | AM process, recorded from the calibrated feedback |
| | from the galvanometer mirror positioning the laser |
| | beam upon the build surface. |
| fuse y-axis | The y-axis position in a 3D coordinate record of |
| position | the AM process, recorded from the calibrated feedback |
| | from the galvanometer mirror positioning the laser |
| | beam upon the build surface. |
| fuse z-axis | The z-axis position in a 3D coordinate record of |
| position | the AM process, recorded from the linear motion |
| | feedback positioning the build surface. |
| fuse laser | The measured and recorded laser power delivered at |
| power | each point in the process point field, laser |
| | intensity feedback channel. |
| fust laser | The measured position of the laser focusing lens |
| focus | calibrated to the focusing field of the build |
| | surface. |
| fuse spot | The laser spot size calibrated to the fuse laser |
| size | focus value across the build surface, as a function |
| | of the fuse x-axis and y-axis positions. |
| fuse time | The time stamp for each point in the process point |
| | field, where each point is the fuse time and position |
| | throughout the build. |
| fuse speed | The calculated speed at each point in the process |
| | point field using the change in position divided by |
| | the change in time between each point and its prior. |
| fuse energy | An intensity value at each point in the process point |
| density | field, calculated from the power, speed, and spot |
| | size at each position in the process point field. |
| fuse thermal | A quantified pre-heat value calculated for any point |
| rise | and from the thermal contributions of prior fuse |
| | points in the process point field. |
| fuse lack of | A quantified lack of fusion, fuse overlap, parameter |
| fusion | calculated for any point from the inferred melt pool |
| | shape and proximity of other fuse points in the |
| | process point field. |
| fuse spatter | A quantified value of spatter field impacting the |
| impact | consistency of the AM process for each fuse point |
| | and the contributions of prior fuse points in the |
| | process point field. |
| in-situ | An in-situ monitoring photographic image of the |
| feedstock | as-spread feedstock prior to the fuse actions per |
| image | layer; the intensity values at each position are |
| | registered to the process point field positions. |
| ex-situ x-ray | A 3D volumetric image of the as-printed material; |
| computed | the intensity or porosity classified voxels at each |
| tomography | position are registered to the process point field |
| volume | positions. |
| image | |
| ex-situ | Voids throughout the material resulting from the |
| porosity | AM build process. |
| ex-situ | Structural features throughout the material resulting |
| microstructure | from the build process and of the micrometer size |
| | range, e.g. crystalline structure, pore structure, |
| | crack structure. |
| predicted | A predicted value calculated from a trained machine |
| porosity | learning model using the fuse process metrics. |

An input parameter may include, for example, a control parameter describing a controllable aspect of the given AM machine, such as, in the case of a laser powder bed fusion (PBF-LB/M) AM machine, an interlayer hatch spacing, laser power, laser position, laser speed, laser spot-size, interlayer hatch angle, interlayer height, laser position relative to the crossflow, crossflow velocity, and the like. An input parameter may be a function of a build time and/or a position in the build space. In other words, an input parameter may be settable based on the build time, and/or a position in a process point field (PPF) describing the three-dimensional space of the build volume (e.g., volume of the part to be formed) and/or potential build volume (e.g., volume of the AM machine in which building is possible, which may be greater than the build volume) such as is described in US Patent Publication No. US2023/0356469A1 the entirety of which is incorporated herein by reference.

A determined metric may include a plurality of determined metrics, for example, an estimated parameter describing a condition of the given AM machine and/or part to be formed, such as, in the case of a laser powder bed fusion (PBF-LB/M) AM machine, for example, a position of the laser, fusing time, power state of the laser, spot size, beam shape on surface, temperature gain on surface, surface temperature, porosity, microstructure, residual stress, and the like. A determined metric may be a function of the build time and/or the position in the build space. In other words, a determined metric may be estimated for discrete time increments of the build time, and/or for a position in a the PPF describing the three-dimensional space of the build volume and/or potential build volume. A determined metric may be estimated through modelling of the AM machine, AM process(es), and/or part to be formed. A determined metric may be determined by a computer configured to execute instructions related to monitoring aspects of the AM machine and/or part being built by the AM machine which may include executing modeling software based on conditions of the build (e.g., real-time measurements, real-time predicted values, and the like).

A measured condition, which may also be used to determine a determined metric, as the found feature, and/or as a defect, may include, for example, a sensed aspect of the given AM machine, AM process, and/or part to be formed, such as, in the case of a laser powder bed fusion (PBF-LB/M) AM machine, for example, input laser power, porosity, build shape (e.g., dimensions of the build volume), surface roughness (e.g., which may also be referred to as surface finish), presence of a crack (e.g., absence of solidified material in a specific location, a defect, a found feature, or the like), microstructure, and the like. A measured condition may be determined by layer wise surface imaging, X-ray computed tomography (XRCT), non-contact dimensional inspection, other non-invasive imaging, and the like. For the purposes of developing a training dataset, invasive imaging and inspection may also be used to determine a found feature and/or a defect (e.g. metallography and serial sectioned metallography). A measured condition may be a function of the build time and/or the position in the build space. In other words, a measured condition may be determined for discrete time increments of the build time, and/or for a position in a the PPF describing the three-dimensional space of the build volume and/or potential build volume. In an implementation, the measured condition may include feedback data (e.g., data fed back to an AM machine controller to improve control of the AM machine and/or AM process).

Once the build parameters are determined for a given build with the AM machine, a second step 120 of the method 100 may include forming a sample part by an AM process with the AM machine based on the build parameters. For example, the build parameters may describe operation of the AM machine at points (e.g., each point) in the PPF that correspond to at least a portion of the part to be formed by the AM machine. For example, the PPF may have higher fidelity portions and lower fidelity portions which may correspond to the importance of part features in those respective portions. In an implementation, a first portion of the build parameters may be of relatively low fidelity (e.g., larger discretized volume(s), longer discretized time(s), and the like) for a portion of the build space and/or build time of a build while a second portion of the build parameters may be of relatively high fidelity (e.g., smaller discretized volume(s), shorter discretized time(s), and the like). In this way, as will be further explained below, the method of the present disclosure may allow for training of an artificial intelligence (AI) model based on only a portion of the part to be built by the AM machine.

The sample part may be a manufacturing check sample, a production check sample, and the like. In an implementation, the sample part may be a production part (e.g., a part which may be sold or otherwise disposed in exchange for consideration). In an implementation, the sample part may be an inspectable part configured to be inspected during (e.g., by in-situ monitoring) or after (e.g., by ex-situ equipment) formation of the inspectable part, which can include imaging by imaging devices (e.g., such as XRCT), measuring by dimensional measuring devices, sensing by a sensor (e.g., sensing surface temperature by an infrared temperature sensor), and the like.

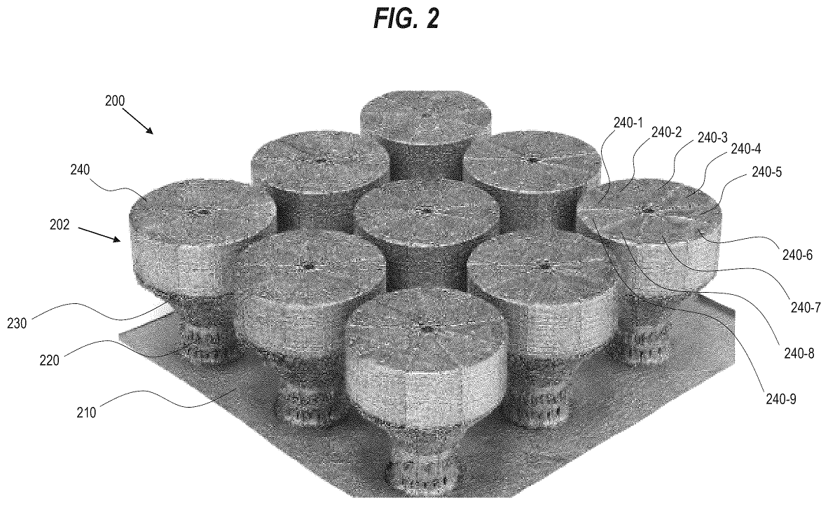

As used herein, an inspectable part may refer to a part which has a variety of inspectable features that may describe different physical characteristics (e.g., structures, properties, dimensions, and the like) of the inspectable part and that may vary throughout the volume of the part. The specific inspectable features may be designed to exercise the AM machine, AM process(es), measurement equipment (e.g., in-situ or ex-situ equipment), and a controller configured to determine determined metrics of the build, or a combination including at least one of the foregoing. An inspectable part will be later described in more detail with reference to FIG. 2. In an implementation, the sample part may include an inspectable geometry including a plurality of inspectable features describing different physical characteristic of the sample part as a function of the PPF, and each build parameter of the build parameters may be equal to an as-designed build parameter for forming the part (e.g., a production part). In an implementation, the forming the sample part may include indexing an interlayer hatch angle between subsequent passes of a forming tool (e.g., a laser) of the AM machine by less than or equal to about 44 degrees, the sample part may include an inspectable geometry including a plurality of inspectable features describing different physical characteristic of the sample part as a function of the PPF, and each build parameter of the build parameters may be equal to an as-designed build parameter for forming the part (e.g., a production part). In an implementation, the forming the sample part may include indexing an interlayer hatch angle between subsequent passes of the forming tool of the AM machine by less than or equal to about 44 degrees, the sample part may include the inspectable geometry including the plurality of inspectable features describing different physical characteristic of the sample part as a function of the point field, and the build parameters may include deviation parameters describing uniform perturbations and/or non-uniform perturbations from a parameter of build parameters. Further, in an implementation, the indexing of the interlayer hatch angle between subsequent passes of the forming tool may include indexing by less than or equal to about 44 degrees, or less than or equal to about 40 degrees, or less than or equal to about 35 degrees, or less than or equal to about 30 degrees, or less than or equal to about 25 degrees, or less than or equal to about 20 degrees, or less than or equal to about 15 degrees, or less than or equal to about 10 degrees, or less than or equal to about 5 degrees, or less than or equal to about 2 degrees, or about 1 degree.

A third step 130 of the method 100 may include determining, during the forming of the sample part, a metric. The metric may include information describing an aspect of the forming (e.g., during the second step 120) at points in the point field. For example, the determined metric may include an aforementioned determined metric for the build which may be determined by a computer executing a model based on an actual condition of the AM machine, the formed part, and/or the AM process as a function of the build time, build space, a state of the AM machine, and/or a state of the AM process. Further, the determined metric may include an aforementioned measured condition for the build which may be sensed by a sensor configured to sense aspects of the AM machine, the formed part, and/or the AM process as a function of the build time, build space, a state of the AM machine, and/or a state of the AM process. In an implementation, the determined metric may include a determined metric of the AM machine, the AM process, and/or the formed sample part, and/or a measured condition of the AM machine, the AM process, and/or the formed sample part.

The third step 130 of the method 100 may include mapping the determined metric into the PPF to expand a data set of the PPF to include additional data describing a condition at a specific location in the build space. This may include appending the determined metric to the input PPF used for the build so that the PPF includes the input parameters and the determined metric. In this way, the PPF may be expanded to be an expanded record of the as-built part. Alternatively, or in addition, the determined metric may be mapped to a duplicate PPF and exist as a standalone data set of the metric as a function of the PPF so as to have a correspondence with the PPF of the input parameters.

A fourth step 140 of the method 100 may include inspecting the formed sample part to find a feature of the sample part as a function of one or more points of the point field. For example, the formed sample part may be inspected during the build (e.g., in-situ monitoring, such as layer-by-layer monitoring) or after the completion of the build to determine a feature of the formed sample part (e.g., an as-built feature). A feature may include a feature intentionally formed in the sample part (e.g., a dimension of the sample part that conforms to the desired build dimension) and/or may include a feature that is non-intentionally formed in the sample part (e.g., a crack, tunnel, deviation from the desired microstructure, dimension, property, and the like).

The fourth step 140 of the method 100 may include classifying the found feature of the formed sample part as a defect such as an out of bound parameter including a crack, a dimensional deviation, microstructure deviation, a thermal deviation, residual stress deviation, surface roughness deviation, porosity deviation, and the like.

The fourth step 140 of the method 100 may include mapping the found feature into the PPF to expand the data set of the PPF to include additional data describing the found feature at a specific location in the build space. This may include appending the found feature to the input PPF model or the input PPF model already appended with data corresponding to determined metric, so that the PPF includes the input parameters, the determined metrics, and/or the found features. In this way, the PPF may be further expanded to become a complete record of the as-built part. In other words, the further expanded PPF may include the input parameters, the determined metric (e.g., the determined metrics and/or the measured conditions), and the found features of a build. Such a PPF may be referred to as a “co-registered point field”. Alternatively, or in addition, the found feature may be mapped to a duplicate PPF and exist as a standalone data set of the found feature as a function of the PPF so as to have a correspondence with the PPF of the input parameters.

Irrespective of whether data of the build (e.g., determined metric and/or found feature) are appended to the input PPF (e.g., in a co-registered point field) or exist as standalone data sets (e.g., corresponding to the input PPF), the entirety of the as-built data may reflect a record of the input parameter, the determined metric, the measured condition, and the found features corresponding to a particular build. In this way, the complete as-built data set may be reflective of relationships between the input parameter, the determined metric, the measured condition, and/or found feature. Considering at least the potential extent of the complete as-built data set, which may at least include hundreds of input parameters and determined metrics for hundreds, if not thousands, of points in a three-dimensional point space describing the build, it may be challenging for a human (even with the aid of a computer configured to execute data analysis software) to establish correlations between the numerous controllable (e.g., input parameters), pseudo-controllable (e.g., determined metrics, measured conditions, and/or found features), and resultant features (e.g., measured conditions and/or found features) in a AM formed part.

A fifth step 150 of the method 100 may include creating a training field including the point field including the build parameter, the determined metrics, and the found features as a single co-registered point field (e.g., as a function of the point field associated with one or more of the build parameters, the determined metrics, and the found features). For example, the complete as-built data set may then be used as a training field. In this way, the training field may include the build parameter (e.g., input parameters), the determined metrics, the measured conditions, and the found features for a particular build. Further, the training field may be appended with data from other builds which may expand the training data set and allow for more accurate identification of specific relationships between the data by an AI model. The fifth step 150 of the method 100 may include appending information of the PPF with information corresponding to the found feature. The fifth step 150 of the method 100 may include determining a quality of the AI model by validating a prediction of the found feature for the plurality of build parameters and determined metric against information excluded from the training field. For example, a portion of the training data may be excluded from the training data set used to train the AI model. The trained AI model may then be used to determine correlations between the input parameters (e.g., the build parameters), determined metrics, measured conditions, and/or found features in the excluded portion of the training data to determine an accuracy of the trained AI model. If the trained AI model is able to predict a portion of data in the excluded data set (e.g., found features) based on another portion of data in the excluded data set (e.g., input parameters, determined metrics, and/or measured conditions) then the AI model may be considered accurate. Whereas, if the trained AI model is unable to predict a portion of data in the excluded data set (e.g., found features) based on another portion of data in the excluded data set (e.g., input parameters, determined metrics, and/or measured conditions) then the AI model may be considered to be inaccurate and further training data may be used to improve the accuracy of the AI model.

A sixth step 160 of the method 100 may include training the build parameters, the metric, and the found feature with the training field using an artificial intelligence (AI) model. For example, the sixth step 160 may include training an AI model by inputting into the AI model one or more data sets representing input parameters, the determined metrics, the measured conditions, and the found features as functions of points in a PPF for one or more builds of the AM machine. The AI model may be any known AI model such as neural network model, machine learning model, deep learning model, deep neural network model, Bayesian network model, and the like. The AI model, trained with the aforementioned data may establish correlations between the input parameters, the determined metrics, the measured conditions, and/or the found features. The established correlations may be non-linear correlations that correlate complex build mechanics (e.g., heating, melting, fusing, fluid flow, cooling, solidification, and the like) to resultant condition in the as-built part.

A seventh step 170 of the method 100 may include forming a part by the AM process with the AM machine based on the trained plurality of build parameters and trained metric so that the feature is effectively absent from the formed part (e.g., where a likelihood of developing the feature is at a mathematical minimum (e.g., a local or an absolute minimum) based on the identified correlations between parameters developed by the AI model). For example, the forming may include modifying the plurality of build parameters based on, or with, the AI model so that unintentional found features, defects, are not present in the formed part. Since relationships between the input parameters, determined metrics, measured conditions, and/or found features are determined by the trained AI model, the AI model can be used to adjust the input parameters so that the resulting determined metrics and/or the measured conditions which may be indicative of unintentional features in the formed part do not occur, thereby avoiding conditions that result in features in a formed part which are not desired.

Alternatively, or in addition, the seventh step 170 of the method 100 may include detecting a probability of the feature being present in the formed part based on inspecting an as-built data set, a PPF having the same build parameters and determined metric used to train the AI model, for a formed part against the trained plurality of build parameters, determined metric, and the found metric. For example, an as-built data set describing the input parameters, determined metrics, and measured conditions associated with a particular build may be input to the trained AI model and the trained AI model may output a probability that a feature (e.g., a defect) is present in the part corresponding to the as-built data set. In this case, the as-built data set and part may correspond to the training data set. For example, the as-built part may be a part having the same material, dimensions, and/or properties of parts built during the development of the training data set. For example, values of the input parameters, determined metrics, and measured conditions for the data set corresponding to the as-built part may be encompassed by the training data in the PPF so that the AI model may interpolate a probability of the feature being present in the as built part. Alternatively, or in addition, values of the input parameter metrics, determined metrics, and measured conditions for the data set corresponding to the as-built part may be outside of the range of data encompassed by the training data so that the AI model may extrapolate a probability of the feature being present in the as built part.

By training the AI model with varied build parameters (e.g., input parameters and determined metrics which include perturbations from a nominal value) which may result in varied training data sets (e.g., including the varied build parameters, varied measured conditions, and varied found features) the AI model may derive correlations that show causal relationships between the build parameters and the found features. With this understanding, the AI model may alter build parameters so that an unintended feature(s) (e.g., defect(s)) is excluded from an as-built part. Further, by excluding the unintended feature from the build, the cost and time associated with post fabrication inspection (e.g., quality assurance activities) and/or scrap may be avoided, part quality may be improved, and overall manufacturing time may be reduced.

In an implementation, the AM machine may include a laser powder bed fusion machine including a laser configured to fuse metal powder stock, the AM process may include a laser powder bed fusion process in which the laser fuses the metal powder stock in a layer-by-layer sequence, and the forming the sample part may include indexing an interlayer hatch angle of the laser between subsequent layers with the AM machine by less than or equal to about 44 degrees.

FIG. 2 show an example of an inspectable part 200. The inspectable part 200 may include a surface 210 onto which the inspectable part 200 is fabricated. The inspectable part 200 may include a plurality of structures 202 and each structure 202 may include a cylindrical body 220 and a disc-shaped lobe 240 which may be connected by a conical transition section 230. The disc-shaped lobe 240 of each structure of the plurality of structures 202 may include any number of sections (e.g., nine or more sections are shown in FIG. 2, where each section includes a pie-shaped wedge) which are joined together to form the disc-shaped lobe 240.

The surface 210 may be a work surface of the AM machine or may be, for example, a sheet including a number of layers of powder metal fused together by the AM machine during the build of the inspectable part 200. For example, the surface 210 may include the first one to about twenty layers, or a first two layers to about ten layers of an AM machine build.

The cylindrical body 220, conical transition section 230, and/or disc-shaped lobe 240 may be formed to include a portion having a specific feature such as including a hole, tunnel (e.g., wormhole), cavity, recess, protrusion, interlayer thickness, porosity, microstructure, surface roughness, wall thickness, and the like, or a combination including at least one of the foregoing.

The specific features may be formed using different input parameters. As a result, a determined metric and/or a determined parameters for different specific features may be varied. For example, in the case of an inspectable part 200 having nine structures 202 as shown in FIG. 2, each disc-shaped lobe 240 may include nine or more sections (240-1 to 240-9). A section of the nine or more sections (240-1 to 240-9) may be distinct from another section of the nine or more sections (240-1 to 240-9). For example, a first section 240-1 of a first disc-shaped lobe 240 may be formed with, for example, a first interlayer hatch angle and/or a first wall thickness (e.g., thickness of a wall portion between adjacent sections and/or thickness of a circumferential wall portion) while a second section 240-2 of the first disc-shaped lobe 240 may be formed with a second interlayer hatch angle and/or second wall thickness which is, respectively, greater than or less than the first interlayer hatch angle and/or first wall thickness. Further, a first section 240-1 of a first disc-shaped lobe 240 may be formed with a first interlayer height while a second section 240-2 of the first disc-shaped lobe 240 may be formed with a second interlayer height which is greater than or less than the first interlayer height. Such differences in input parameters may result in the first section 240-1 having a one or more different determined metric and/or a determined parameters from the second section 240-2. This may allow for sections of the inspectable part 200 to be formed with a variety of input parameters thereby allowing for perturbations in input parameters to exercise the AM machine processing for a given material. Further, as a result of such perturbations in input parameters, perturbations to determined metrics of the build may occur and/or perturbations to measured conditions may result. Accordingly, an inspectable part 200, for example, having nine structures 202 each with nine sections (240-1 to 240-9) where each section is formed based on different input parameters may allow for 81 (e.g., 9×9) different sets of input parameters for a single build.

In this way, an inspectable part 200 having many discrete portions may be able to exercise the AM process and/or AM machine to form a part with hundreds, thousands, millions, if not billions of variations in input parameters, determined metrics, and/or measured conditions. Accordingly, by forming inspectable part 200 a data set including variations in input parameters, determined metrics, and/or measured conditions may be determined which may be used to train an AI model. Specifically, the AI model may be trained to correlate variations in each input parameter, determined metric, and/or measured conditions with one or more other input parameter, determined metric, and/or measured conditions. This may result in a potentially very large (e.g., processor intensive), and potentially complex, set of relationships between metrics (e.g., input parameters, determined metrics, and/or measured conditions) for an AM build which may only be understood (e.g., determinable) and harnessed (e.g., manipulated) by a trained AI model capable of identifying this set of relationships. Further, considering that a data set for a build as presented herein may include hundreds (e.g., and up to billions) of variable values (e.g., input parameters, determined metrics, and/or measured conditions) for each point in at least a portion of a PPF (e.g., which may include hundreds to hundreds of thousands of dimensional locations) it may be understood that resolving correlations between these variable values may be impossible to perform in the human mind without the aid of a trained AI model.

The shape and specific features of the inspectable part 200 are meant only as illustrative of an inspectable part 200 within the meaning of the present disclosure. Other structures, e.g., having different shapes, dimensions, materials, and/or features are within the scope of the present disclosure. For example, the plurality of structures 202 of the inspectable part 200 may not include a cylindrical body 220 and/or a conical transition section 230. Further, an inspectable part 200 may include lobes having conical, pyramidal, cubic, polygonal, or other shapes.

The disclosed implementations may be implemented as an apparatus (a machine) that includes processing hardware configured, for example, by way of software executed by the processing hardware and/or by hardware logic circuitry, to perform the described features, functions, operations, processes, methods, steps, and/or benefits.

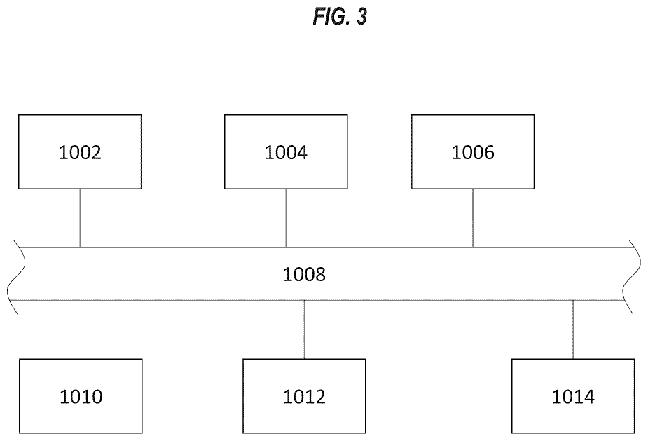

The disclosed implementations may include a computing apparatus, such as (in a non-limiting example) any computer or computer processor, that includes processing hardware and/or software implemented on the processing hardware to transmit and receive (communicate (network) with other computing apparatuses), store and retrieve from computer readable storage media, process and/or output data. According to an aspect of an implementation, the described features, functions, operations, processes, methods, steps, and/or benefits may be implemented by and/or use processing hardware and/or software executed by processing hardware. For example, a computing apparatus as illustrated in FIG. 3 may include a central processing unit (CPU) or a computing processing system 1004 (e.g., one or more processing devices (e.g., chipset(s), including memory, etc.) that may process or execute instructions, namely software, program(s), and/or application(s), which may be stored in a memory 1006 and/or a computer readable storage media 1012 (e.g., read-only memory (ROM), flash memory, hard disk, solid state memory, and the like), transmission communication interface (e.g., network interface, wire/wireless data network interface) 1010, input device 1014 (e.g., mouse, keyboard, multi-touch display, audio microphone, sensor, and the like), and/or an output device 1002, for example, a display device (e.g., multi-touch display, audio speaker, visual display, and the like), a printing device, and which are coupled (directly or indirectly) to each other, for example, may be in communication among each other through one or more data communication buses 1008.

In an implementation, the computing apparatus may be a controller configured to control and/or monitor the AM machine, the AM process, a part being formed by the AM machine, or a combination including at least one of the foregoing. For example, the controller may be configured to control controllable aspects of the AM machine during formation of a part with the AM machine. The controller may be configured to execute models (e.g., physics-based and/or empirically derived models) intended to represent the AM machine, the AM process, a part being formed by the AM machine, or a combination including at least one of the foregoing.

In addition, an apparatus may include one or more apparatuses in computer network communication with each other or other apparatuses and the implementations relate to control and/or communication of aspects of the disclosed features, functions, operations, processes, methods, steps, and/or benefits, for example, data or information involving local area network (LAN) and/or Intranet based computing, cloud computing in case of Internet based computing, Internet of Things (IOT) (network of physical objects-computer readable storage media (e.g., databases, knowledge bases), devices (e.g., appliances, cameras, mobile phones), vehicles, buildings, and other items, embedded with electronics, software, sensors that generate, collect, search (query), process, and/or analyze data, with network connectivity to exchange the data), online websites. In addition, a computer processor may refer to one or more computer processors in one or more apparatuses or any combinations of one or more computer processors and/or apparatuses. An aspect of an implementation relates to causing and/or configuring one or more apparatuses and/or computer processors to execute the described operations. The results produced may be output to an output device, for example, displayed on the display or by way of audio/sound. An apparatus or device refers to a physical machine that performs operations by way of electronics, mechanical processes, for example, electromechanical devices, sensors, a computer (physical computing hardware or machinery) that implement or execute instructions, for example, execute instructions by way of software, which is code executed by computing hardware including a programmable chip (chipset, computer processor, electronic component), and/or implement instructions by way of computing hardware (e.g., in circuitry, electronic components in integrated circuits, etc.)—collectively referred to as hardware processor(s), to achieve the functions or operations being described. The functions of embodiments described may be implemented in a type of apparatus that may execute instructions or code.

More particularly, programming or configuring or causing an apparatus or device, for example, a computer, to execute the described functions of implementation of the disclosure creates a new machine where in case of a computer a general-purpose computer in effect becomes a special purpose computer once it is programmed or configured or caused to perform particular functions of the implementations of the disclosure pursuant to instructions from program software. According to an aspect of an embodiment, configuring an apparatus, device, computer processor, refers to such apparatus, device or computer processor programmed or controlled by software to execute the described functions.

A program/software implementing the embodiments may be recorded on a computer-readable storage media, e.g., a non-transitory or persistent computer-readable storage medium. Examples of the non-transitory computer-readable media include a magnetic recording apparatus, an optical disk, a magneto-optical disk, and/or volatile and/or non-volatile semiconductor memory (for example, random access memory (RAM), ROM, etc.).

Examples of the magnetic recording apparatus include a hard disk device (HDD), a flexible disk (FD), and a magnetic tape (MT). Examples of the optical disk include a DVD (Digital Versatile Disc), DVD-Read-only memory (DVD-ROM), DVD-Random Access Memory (DVD-RAM), BD (Blue-ray Disk), a Compact Disc (CD)—Read Only Memory (CD-ROM), a CD-Recordable (CD-R) and/or CD-Rewritable (CD-RW). The program/software implementing the embodiments may be transmitted over a transmission communication path, e.g., a wire and/or a wireless network implemented via hardware. An example of communication media via which the program/software may be sent includes, for example, a carrier-wave signal.

As used herein, each of the phrases such as “A or B,” “at least one of A and B,” “at least one of A or B,” “A, B or C,”, A, B, and C″, “at least one of A, B, and C,” and “at least one of A, B, or C” may include any one of the listed items, or all possible combinations thereof. For example, use of “at least one of” preceding a group of items should be interpreted in a disjunctive way with respect to the group of items, e.g., so that presence of one item of the group meets the meaning of the recitation.

As used herein, the words “a,” “an” and “the” are intended to include plural forms of elements unless specifically referenced as a single element.

As used herein, the term “and/or” includes a combination of a plurality of related listed components, or any component among the plurality of related listed components.

As used herein, terms such as “first,” “second,” or “first” or “second” may be used simply to distinguish one component from other components, and do not limit the components in other aspects (e.g., importance or order).

As used herein, the terms “comprise(ing)”, “include(ing)” or “have(ing)” are intended to indicate the presence of a characteristic, number, step, operation, process, component, part, feature, function, and/or element, or any combination thereof described in the present document, and the possibility of the presence or addition of one or more other characteristics, numbers, steps, operations, processes, components, parts, features, functions, and/or elements, or any combination thereof is not precluded.

As used herein, when a component is “connected,” “coupled,” “supported,” or “in contact” with another component, this includes not only cases in which components are directly connected, coupled, supported, or in contact with each other, but also cases in which they are indirectly connected, coupled, supported, or in contact through a third component.

As used herein, when a component is disposed “on” another component, this includes not only a case in which the component is in contact with another component, but also a case in which still another member is present between the two components.

As used herein, a term, such as “about” or “substantially,” is used at a corresponding numerical value or used as a meaning close to the numerical value when e.g., manufacturing and material tolerances which may be inherent in the stated meaning are presented. In particular, as used herein, the terms “about” and “approximately” refer to values that are plus or minus ten percent of the base value. That is, for example, reference to “about 100” or “approximately 100” refers to “90-110” inclusive. In some implementations, “about” may refer to plus or minus five percent of the base value, or plus or minus two percent of the base value.

What is claimed is:

1. A method comprising:
forming a sample part by an additive manufacturing (AM) process with an AM machine based on build parameters describing operation of the AM machine at points of a point field corresponding to at least a portion of the sample part;
determining, during the forming the sample part, a metric including information describing an aspect of the forming at the points in the point field;
inspecting the sample part to find a feature of the sample part as a function of one or more points of the point field;
creating a training field including the point field, the build parameters, the determined metric, and the found feature as a single co-registered point field;
training the build parameters and the determined metric, with the found feature as the training field using an artificial intelligence (AI) model; and
forming a part by the AM process with the AM machine based on the trained build parameters and the trained determined metric, so that the found feature is effectively absent from the formed part and/or detecting a probability of the found feature being present in the formed part based on the AI model inspecting an as-built data set for a formed part against the trained build parameters and the trained determined metric.

2. The method of claim 1, wherein
the determined metric includes:
a determined metric of the AM machine, the AM process, and/or the formed sample part, and/or
a measured condition of the AM machine, the AM process, and/or the formed sample part.

3. The method of claim 1, further comprising classifying the feature of the formed sample part.

4. The method of claim 1, wherein the creating the training field further includes appending information of the point field with information corresponding to the found feature.

5. The method of claim 1, further comprising determining a quality of the AI model by validating a prediction of the found feature for the build parameters and the determined metric against information excluded from the training field.

6. The method of claim 1, wherein
the sample part includes an inspectable geometry including a plurality of inspectable features describing different physical characteristics of the sample part as a function of the point field, and
each build parameter of the build parameters is equal to an as-designed build parameter for forming the part.

7. The method of claim 6, wherein
the forming the sample part includes indexing an interlayer hatch angle between subsequent passes of a forming tool of the AM machine by less than or equal to about 44 degrees.

8. The method of claim 1, wherein
the forming the sample part includes indexing an interlayer hatch angle between subsequent passes of a forming tool of the AM machine by less than or equal to about 44 degrees,
the sample part includes an inspectable geometry including a plurality of inspectable features describing different physical characteristic of the sample part as a function of the point field, and
the build parameters include deviation parameters describing uniform perturbations and/or non-uniform perturbations from a parameter of the build parameters.

9. The method of claim 1, wherein
the AM machine includes a laser powder bed fusion machine including a laser configured to fuse metal powder stock,
the AM process includes a laser powder bed fusion process in which the laser fuses the metal powder stock in a layer-by-layer sequence, and
the forming the sample part includes indexing an interlayer hatch angle of the laser between subsequent layers with the AM machine by less than or equal to about 44 degrees.

10. The method of claim 1, wherein the inspecting includes XRCT imaging, profilometry, and/or metallography of one or more layers of the sample part.

11. The method of claim 1, wherein the metric includes a plurality of determined metrics and/or a plurality of measured conditions respectively corresponding to points in the point field.

12. The method of claim 1, wherein the feature includes a defect.

13. An additive manufacturing machine comprising:
a tool; and
a controller configured to:
form a sample part by an additive manufacturing (AM) process with an AM machine based on build parameters describing operation of the AM machine at points of a point field corresponding to at least a portion of the sample part;
determine, during the forming the sample part, a metric including information describing an aspect of the forming at the points in the point field;
inspect the sample part to find a feature of the sample part as a function of one or more points of the point field;
create a training field including the point field, the build parameters, the determined metric, and the found feature as a single co-registered point field;
train the build parameters and the determined metric, with the found feature as the training field using an artificial intelligence (AI) model; and
form a part by the AM process with the AM machine based on the trained build parameters and determined metric, so that the feature is effectively absent from the formed part and/or detect a probability of the found feature being present in the formed part based on an as-built data set for a formed part inspected by the AI model against the trained build parameters and determined metric.

14. The additive manufacturing machine of claim 13, wherein
the determined metric includes:
a determined metric of the AM machine, the AM process, and/or the formed sample part, and/or
a measured condition of the AM machine, the AM process, and/or the formed sample part.

15. The additive manufacturing machine of claim 13, wherein
the controller is further configured to:
classify the feature of the formed sample part.

16. The additive manufacturing machine of claim 13, wherein
the controller is further configured to:
validate a prediction of the found feature for the build parameters and the determined metric against information excluded from the training field so as to determine a quality of the AI model.

17. The additive manufacturing machine of claim 13, wherein
the sample part includes an inspectable geometry including a plurality of inspectable features describing different physical characteristics of the sample part as a function of the point field, and
each build parameter of the build parameters is equal to an as-designed build parameter for forming the part.

18. The additive manufacturing machine of claim 17, wherein
the controller is further configured to:
index an interlayer hatch angle between subsequent passes of a forming tool of the AM machine by less than or equal to about 44 degrees to form the sample part.

19. The additive manufacturing machine of claim 13, wherein
the controller is further configured to:
index an interlayer hatch angle between subsequent passes of a forming tool of the AM machine by less than or equal to about 44 degrees to form the sample part,
the sample part includes an inspectable geometry including a plurality of inspectable features describing different physical characteristic of the sample part as a function of the point field, and
the build parameters include deviation parameters describing uniform perturbations and/or non-uniform perturbations from a parameter of the build parameters.

20. The additive manufacturing machine of claim 13, wherein
the tool includes a laser configured to fuse metal powder stock in a build volume of the AM machine, and the controller is further configured to:
control the laser to fuse the metal powder stock in a layer-by-layer sequence.
